(19) United States
(12) Patent Application Publication
(10) Pub. No.: US 2011/0043692 A1
(43) Pub. Date: Feb. 24, 2011

(54) VIDEO PROJECTION SYSTEM AND SYNCHRONIZATION METHOD

(75) Inventors: Markus Baier, Muenchen (DE); Martin Brueckel, Shenzhen (CN); Andreas Huber, Maisach (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/812,966

(22) PCT Filed: Jan. 18, 2008
(86) PCT No.: PCT/EP2008/050565

§ 371 Date: Jul. 15, 2010

(51) Int. Cl. H04N 5/04

(52) U.S. Cl. 348/500; 348/E05.009

(57) ABSTRACT

In a video projection system, an operating device (12) activates a lamp (10), so that it delivers light with intensity which changes over time. A light modulation unit (16) is provided to apply image information to the light and is activated by a control unit (18) for this purpose. The operating device (12) and control unit (18) must be synchronized. While in the prior art the control unit transmits synchronization signals to the operating device (12), a reversal is provided according to the invention, i.e., the operating device (12) is designed to transmit synchronization signals to the control unit (18).

### TECHNICAL FIELD

The invention relates to a video projection system according to the preamble of patent claim 1, and to a synchronization method according to the preamble of patent claim 5.

### PRIOR ART

A video projection system has a light source, which is caused to emit light with a temporally variable intensity by an operating device. The light is fed to a light modulation unit in order that the latter can impress image information. Usually the light source emits white light (an HID lamp can be involved), and the light modulation unit simply filters the light. This can be done using a so-called color wheel, which has to be brought into a suitable position. The light modulation unit is driven by a control unit. A changing intensity of the light emitted by the light source is associated with the final image. The reason why it is necessary to emit light with a changing intensity is, for example, that the color filters in light modulation units often have different effects: the light should acquire a higher intensity in the case of a first color than in the case of another color. Consequently, the driving of the light source has to be synchronized with that of the light modulation unit. For this purpose, the operating device and the control unit are coupled to one another, e.g. connected to one another via a signal line. Synchronization signals then have to be transmitted via such a signal line. In the prior art, then, it is the control unit which emits the synchronization signal to the operating device of the light source. The synchronization signal is in a fixed phase relationship with the light modulation unit. The operating device synchronizes the frequency (average pulse duration), the temporal profile and preferably also so-called commutations of the lamp current, that is to say boosts in intensity before changing, with the synchronization signal obtained from the control unit. EP 1 345 427 A1 describes that the synchronization signals can acquire a predetermined pattern by way of which, alongside the actual synchronization, complex information is additionally transmitted.

It has been found that, in video projection systems of the prior art, the synchronization does not always function in a manner free of errors. The electronics in the control unit are often dimensioned incorrectly and unsuitable for the error-free outputting of synchronization signals. Disturbances or errors in the generation or transmission of the synchronization signal can occur; by way of example, individual pulses can completely fail, or so-called jitter (a specific type of noise) can arise. The emission of light by the light source then does not ideally match the light modulation unit; in particular, the lamp frequency can be incorrect, there can be an unallowed offset component in the lamp current, and individual light segments (pulse components in the luminous flux) can have an incorrect duration or intensity.

### SUMMARY OF THE INVENTION

The object of the present invention is to provide a video projection system in accordance with the preamble of patent claim 1 wherein the emission of light by the light source is coupled to the light modulation unit better than in the prior art.

In the case of a video projection system comprising the features of the preamble of patent claim 1, this object is achieved by means of the features of the characterizing part of patent claim 1. The object is also achieved by the provision of a method comprising the features in accordance with patent claim 5.

Particularly advantageous configurations are found in the dependent claims.

According to the invention, therefore, the operating device is designed to transmit synchronization signals to the control unit, preferably only the operating device and no longer the control unit. The electronics of a conventional operating device (which, in the case of lamps, is also referred to as an electronic ballast) are significantly less susceptible to errors than the electronics used in the control units for the light modulation unit in the prior art. Moreover, it is advantageous anyway for the synchronization signals to be emitted by that device which has more complex driving, since the operating device has to take account of a multiplicity of parameters during the emission of light. In the case of the light modulation unit, the driving is generally simpler, and so a color wheel merely has to be rotated into a specific angle.

As is also known from the prior art, the control unit can be designed to transmit control signals for defining operating parameters of the light source to the operating device. Unlike in EP 1 345 427 A1, however, a coupling of these control signals to the synchronization signals is no longer necessary. The control signals can now simply digitally specify numerical values for defining the operating parameters.

It is entirely possible for the control unit to retain a certain influence on the synchronization and to exert this influence by way of the transmission of the control signals for defining operating parameters of the light source. This is possible when the operating device is designed to form different synchronization signals or synchronization signal sequences in the case of at least two different operating parameters.

Alongside the actual synchronization signals, the operating device can also communicate information that does not relate to the synchronization, and the operating device can thus provide the control unit with information about the lamp power, e.g. about the lamp voltage and the lamp current, and also the so-called pulse-plateau ratio. The pulse-plateau ratio designates the ratio between an intensity boost before the change in intensity (pulse) and the length of the actual light emission (plateau).

### BRIEF DESCRIPTION OF THE DRAWING

The invention will be explained in greater detail below on the basis of an exemplary embodiment. In the FIGURE:

FIG. 1 shows a schematic illustration of a video projection system according to the invention, in which the method according to the invention can be used.

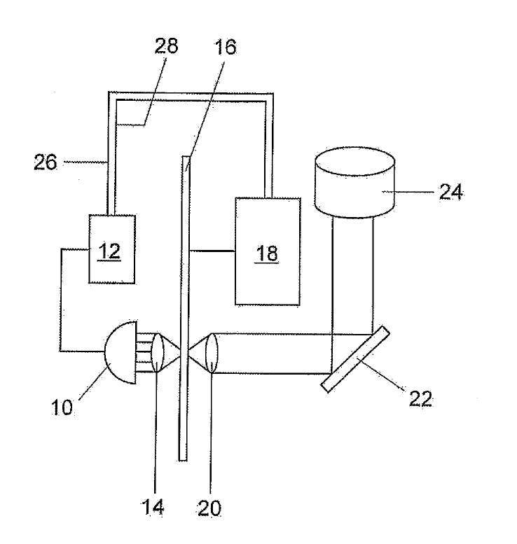

### PREFERRED EMBODIMENT OF THE INVENTION

In the video projection system shown in the FIGURE there is a lamp 10, which is driven by an operating device (an electronic ballast) 12 and emits light. The intensity of the light emitted by the lamp 10 changes between individual partial time segments. The light is concentrated by a suitable optical unit 14 (a lens is shown schematically) onto a predetermined location of a light modulation unit 16, which is driven by a control unit 18. The light modulation unit 16 can be embodied as a so-called color wheel, which is rotated in a manner controlled by the control unit 18. For each angle of rotation, the light passes through a different filter, as a result of which the light modulation unit 16 impresses color information on the light emerging from the light source 10. The light subsequently passes through a further optical unit 20 (once again a lens is shown) and passes via a deflection mirror 22 to an outlet 24. The deflection mirror 22 can have a multiplicity of individual pivotable mirror elements, such that a light beam is directed to that pixel on a screen or a projection screen at which the color impressed by the color wheel 16 is intended to be defined.

It is then necessary for the emission of the light by the lamp 10 to be synchronized with the setting of the light modulator 16. For this purpose, the operating device 12 and the control unit 18 are coupled to one another via connecting lines 26 and 28. For synchronization purposes, the operating device 12 then transmits synchronization signals via the first connecting line 26 to the control unit 18. The operating device 12 conversely receives, via the second connecting line 28, control signals with the aid of which the control unit 18 defines specific operating parameters of the lamp 10. Operating parameters can be the frequency of the lamp current, that is to say the average period duration between each two changes in the current intensity and hence the intensity of the emitted light. The operating parameters can also define the temporal profile, that is to say variations in the individual period durations.

The operating device 12 reports back, by means of signals impressed on the synchronization signals, information about lamp voltage, lamp current, lamp power, about the frequency and also the pulse-plateau ratio to the control unit 18.

The synchronization functions particularly well by virtue of the fact that, in the present case, the operating device 12 generates the synchronization signals.

1. A video projection system, comprising:
a light source, which is caused to emit light with a temporally variable intensity by an operating device during operation; and
a light modulator which is caused to apply image information to the light emerging from the light source by a controller during operation,
the operating device being coupled to the controller in order to enable them both to be synchronized,
wherein the operating device is designed to transmit synchronization signals to the controller.

2. The video projection system as claimed in claim 1, wherein the controller is designed to transmit control signals for defining operating parameters of the light source to the operating device.

3. The video projection system as claimed in claim 2, wherein the operating device is designed to form different synchronization signals or synchronization signal sequences in the case of at least two different operating parameters.

4. The video projection system as claimed in claim 1,
wherein the operating device is designed to communicate information that does not relate to the synchronization with the synchronization signals.

5. A method for synchronizing the driving of a light source in a video projection system by an operating device, firstly, and of a light modulator in the video projection system by a controller, secondly, wherein the operating device emits synchronization signals to the controller.
